(19) United States
(12) Patent Application Publication
(10) Pub. No.: US 2008/0152090 A1
(43) Pub. Date: Jun. 26, 2008

(54) Euv Light Source

(76) Inventors: Takashi Yamada, Osaka (JP); Hiroaki Nishimura, Osaka (JP)

Correspondence Address: SUGHRUE MION, PLLC, 2100 PENNSYLVANIA AVENUE, N.W., SUITE 800, WASHINGTON, DC, 20037, US

(21) Appl. No.: 10/568,087

(22) PCT Filed: Aug. 19, 2004
(86) PCT No.: PCT/JP2004/011905

§ 371 Date: Feb. 13, 2006

(30) Foreign Application Priority Data
Aug. 25, 2003 (JP) 2003-299927

(51) Int. Cl. H01J 35/00

(52) U.S. Cl. 378/124

(57) ABSTRACT

An EUV light source having a simple structure which is capable of generating EUV stably with a sufficient intensity and serves as an alternative to a laser plasma light source. The EUV light source comprises an X-ray tube (1) having a primary target, and a secondary target (4) being irradiated with X-rays (2) emitted from the X-ray tube (1). The secondary target (4) generates fluorescence X-rays (5) selected from a group of BeKα line, Si-L line and Al-L line.

### BACKGROUND OF THE INVENTION

1. Field of the Invention

The present invention relates to a light source capable of emitting EUV (Extreme UltraViolet) rays of light of a wavelength region of 13.5 nm.

2. Description of the Prior Art

In recent years, as an exposure light source for use in the manufacture of semiconductor devices, development is conducted of a laser plasma light source in which liquefied xenon is irradiated with an YAG laser beam to emit EUV rays of light having a wavelength region in the vicinity of 13.5 nm. See, for example, the Japanese Laid-open Patent Publication No. 2003-185798, paragraph [0003]. In order to evaluate the light source now under development, the optical system for use in evaluation requires the use of a diffraction grating, an artificial multilayer mirror and a filter and, on the other hand, in order to evaluate this optical system, a light source capable of emitting EUV rays of light of a wavelength region in the vicinity of 13.5 nm is required as a light source for use in evaluation, that can be used as an alternative to the light source now under development. As this light source for use in evaluation, some light sources are available such as, for example, a light source for emitting SR (Synchrotron Radiation) light, a light source for emitting discharge plasmas and a light source for emitting electron beams towards an Si target to generate the EUV light.

However, huge facilities are required to secure the SR light on one hand and, on the other hand, the discharge plasma has a difficulty in stabilized operation. Also, emission of the electron beams towards the Si target is accompanied by emission of visible rays of light and infrared rays of light and, therefore, the light source must be have its light emitting portion provided with a window such as, for example, a Be film, which leads to considerable reduction in intensity of the EUV light. In addition, since the surface of the Si target is susceptible to damages caused by the electron beams, a long term stabilized operation is difficult to achieve.

### SUMMARY OF THE INVENTION

The present invention has been devised in view of the foregoing problems and inconveniences inherent in the conventional light sources and is intended to provide an EUV light source of a simplified structure capable of emitting the EUV light of a sufficient intensity in a stabilized manner and which can be used as an alternative to the laser plasma light source.

In order to accomplish the foregoing object of the present invention, the EUV light source designed in accordance with the present invention includes an X-ray tube having a primary target, a secondary target adapted to be irradiated with X-rays emitted from the X-ray tube, wherein fluorescence X-rays selected from the group consisting of Be-Kα line, Si-L line and Al-L line are emitted from the secondary target.

According to the present invention, the secondary target is irradiated with the X-rays emitted from the X-ray tube to emit Be-Kα line (of 11.4 nm in wavelength), Si-L line (of 13.55 nm in wavelength) or Al-L line (17.14 nm in wavelength) as the EUV light. Accordingly, with a simplified structure, the EUV rays of a sufficient intensity can be stably generated and can be used as an alternative to the laser plasma light (of 13.5 nm in wavelength).

In the present invention, the X-rays emitted from the X-ray tube are used to excite electrons of a Si-K shell, which in turn generate Si-L line by cascade excitation. In addition to this, an oxide film on a surface of the secondary target is more preferably removed. Also, the X-rays emitted from the X-ray tube are preferably concentrated by a poly-capillary before they are impinged upon the secondary target. In addition, the X-rays emitted from the secondary target are monochromated by an artificial multilayer mirror or a total reflection mirror into the single fluorescence X-rays.

### BRIEF DESCRIPTION OF THE DRAWINGS

FIG. 1 is a schematic diagram showing an EUV light source according to a preferred embodiment of the present invention.

### DETAILED DESCRIPTION OF THE EMBODIMENTS

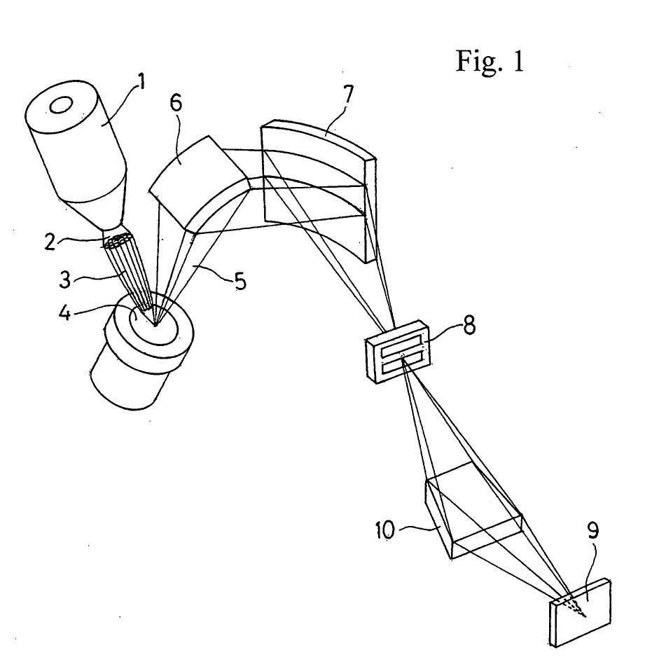

Hereinafter, an EUV light source according to a preferred embodiment of the present invention will be described in detail. This light source includes, as shown in FIG. 1, an X-ray tube 1 having Mo, Rh, Pd or Cr as a primary target, and a secondary target 4 of Si, which is irradiated with X-rays 2 (Mo-Lα line (0.541 nm in wavelength), Rh-Lα line (0.460 nm in wavelength), Pd-Lα line (0.437 nm in wavelength) or Cr-Kα line (0.229 nm in wavelength), depending on the primary target). The secondary target so irradiated with the X-rays 2 generates, as the EUV rays, Si-L line 5 which are fluorescence X-rays.

Since it is not easy to efficiently and directly excite a Si-L shell with the X-rays 2 emitted from the X-ray tube 1, the X-rays 2 emitted from the X-ray tube 1 are utilized to excite electrons of the Si-K shell, which in turn generate the Si-L line 5 by cascade excitation. The presence of an oxide film on a surface of the secondary target 4 of Si makes it difficult to generate the Si-L line 5 and this is particularly true where an oxide film of a film thickness greater than that of a natural oxide film formed by, for example, a heat treatment and, accordingly, in the light source according to the illustrated embodiment, the oxide film on the surface of the secondary target 4 of Si is removed by the use of hydrofluoric acid. Since this light source including the secondary target 4 is in practice used under the vacuum atmosphere, the oxide film is no longer formed on the surface of the secondary target 4 during the use of the light source subsequent to the removal thereof from the secondary target surface.

It is to be noted that as the EUV rays, Be-Kα line or Al-L line may be generated, in which case Be or Al is correspondingly used for the second target 4, respectively. Where the Be-Kα line are desired to be generated, no cascade excitation is used, but the Be-K shell is directly irradiated with the X-rays 2 from the X-ray tube 1. On the other hand, where the Al-L line are desired to be generated, the cascade excitation is employed as is the case with the Si-L line.

With the light source according to this embodiment, the X-rays 2 emitted from the X-ray tube 1 are concentrated by a poly-capillary 4 before they project onto the secondary target 4. X-rays 5 generated from the secondary target 4 as a result of impingement of the X-rays 2 contain not only the Si-L line of interest, but also Si-K line and scattered radiations of the X-rays 2 emitted from the X-ray tube 1, but can be monochromated into the Si-L line through the Bragg diffraction occurring at the artificial multilayer mirror 6 (of a curved type in the illustrated embodiment). The Si-L line, which has undergone the Bragg diffraction at the artificial multilayer mirror 6 are total reflected by a total reflection mirror 7 (of a curved type in the illustrated embodiment) so as to converge at a slit 8 and are, after having passed through the slit 8, projected onto, for example, a diffraction grating 10 subject to evaluation. Thereafter, the Si-L line are, after having been diffracted by the diffraction grating 10, condensed onto and impinge upon a CCD 8 which is a detector.

The Si-L line having passed through the slit 8 undergo the Bragg diffraction where the subject to be evaluated is the artificial multilayer mirror, but are filtered where the subject to be evaluated is a filter, before they impinge on the CCD 9. Where the subject to be evaluated is the artificial multilayer mirror or the filter, an X-ray detector such as F-PC may be employed as the detector in place of the CCD.

The artificial multilayer mirror 6 and the total reflection mirror 7 are arranged in a so-called KB (Kirkpatrick-Baez) system so that vertical and horizontal components of the X-rays 5 generated from the secondary target 4 can be concentrated independently and separately from each other. Also, since if both of the artificial multilayer mirror 6 and the total reflection mirror 7 undergo reflection at the Brewster angle, the intensity of the Si-L line disappears, the angle of reflection of at least one of them should be set to depart from that of the other of them.

It is to be noted that since the X-rays 5 generated from the secondary target 4 contain little X-rays of a longer wavelength than that of the Si-L line, a total reflection mirror may be employed in place of the artificial multilayer mirror 6 so that it may cooperate with the total reflection mirror 7 to allow the X-rays 5 generated from the secondary target 4 to undergo the total reflection twice. By so doing, X-rays of a shorter wavelength than that of the Si-L line (such as, for example, Si-K line and scattered radiations of the X-rays 2 emitted from the X-ray tube 1) can be eliminated to render them to be monochromated into the Si-L line. In addition, where the detector 9 has a sufficiently high energy resolution, no monochromatization is needed and, therefore, without the artificial multilayer mirror 6 and the total reflection mirror 7 being employed, the X-rays 5 generated from the secondary target 4 can be directly projected onto the slit 8.

With the light source according to the foregoing embodiment, since the X-rays 2 emitted from the X-ray tube 1 are projected onto the secondary target 4 of Si so that the Si-L line (13.55 nm in wavelength) can be generated as the EUV rays, the EUV rays of a sufficient intensity can be stably generated with a simplified structure and can be used as an alternative to the laser plasma light (of 13.5 nm in wavelength). Specifically, since the X-rays 2 emitted from the X-ray tube 1 excite electrons of the Si-K shell at the secondary target 4 to cause the Si-L line 5 to be generated by cascade excitation, the EUV rays 5 can be particularly efficiently generated. And when no oxide film appear on the surface of the secondary target 4 of Si, the EUV rays 5 can be more efficiently generated. Also, since the X-rays 2 emitted from the X-ray tube 1 are concentrated by the poly-capillary 3 into a bundle of, for example, 150 μm in diameter, which are subsequently projected onto the secondary target 4, it can be highly advantageously used as an alternative to the laser plasma light source that is concentrated into a fine bundle. In addition, since the X-rays 5 generated from the secondary target 4 are monochromated into the Si-L line by the artificial multilayer mirror 6, the detector 9 may not be required to have an energy resolution.

It is to be noted that in the practice of the present invention, the X-rays from the X-ray tube may be directly projected onto the secondary target without the poly-capillary employed to concentrate them. Also, for the optical system, the parallel beam method (in which a combination of a flat type artificial multilayer mirror or a flat type total reflection mirror and a Soller slit is employed), not the focusing method, may be employed. In addition, the number of the artificial multilayer mirror(s) and the total reflection mirror(s) may not be always limited to plurality in total, but a single artificial multilayer mirror or a single total reflection mirror may be employed in total. By way of example, the present invention equally encompasses such an EUV light source in which the X-rays from the X-ray tube are, without being concentrated, projected onto the secondary target to cause the X-rays to be generated from the secondary target, which X-rays from the secondary target are, after having passed through the Soller slit, monochromated into the EUV rays by means of a single flat type artificial multilayer mirror and are then projected onto the subject to be evaluated.

What is claimed is:

1. An EUV light source which comprises:
an X-ray tube having a primary target; and
a secondary target adapted to be irradiated with X-rays emitted from the X-ray tube;
wherein fluorescence X-rays selected from the group consisting of Be-Kα line, Si-L line and Al-L line are emitted from the secondary target.

2. The EUV light source as claimed in claim 1, wherein the X-rays emitted from the X-ray tube excite electrons of a Si-K shell, which in turn generate Si-L line by cascade excitation.

3. The EUV light source as claimed in claim 1, wherein an oxide film on a surface of the secondary target is removed.

4. The EUV light source as claimed in claim 1, further comprising a poly-capillary for concentrating the X-rays emitted from the X-ray tube before they are projected onto the secondary target.

5. The EUV light source as claimed in claim 1, further comprising an artificial multilayer mirror or a total reflection mirror and wherein X-rays generated from the secondary target are monochromated into the single fluorescence X-rays by means of the artificial multilayer mirror or the total reflection mirror.
